(19) United States
(12) Patent Application Publication
(10) Pub. No.: US 2014/0226842 A1
(43) Pub. Date: Aug. 14, 2014

(54) SPATIAL AUDIO PROCESSING APPARATUS

(71) Applicants: Ravi Shenoy, Karnataka (IN); Pushkar Prasad Patwardhan, Maharashtra (IN)

(72) Inventors: Ravi Shenoy, Karnataka (IN); Pushkar Prasad Patwardhan, Maharashtra (IN)

(73) Assignee: Nokia Corporation, Espoo (FI)

(21) Appl. No.: 14/118,854

(22) PCT Filed: May 15, 2012
(86) PCT No.: PCT/FI2012/050465

§ 371 Date: Feb. 3, 2014

(30) Foreign Application Priority Data
May 23, 2011 (IN) 1748/CHE/2011

(51) Int. Cl. H04S 7/00

(52) U.S. Cl. CPC H04S 7/303
USPC 381/303

(57) ABSTRACT

An apparatus comprising: an input configured to receive at least one audio signal, wherein each audio signal is associated with a source; a signal definer configured to define a characteristic associated with each audio signal; and a filter configured to filter each audio signal dependent on the characteristic associated with the audio signal.

### FIELD OF THE APPLICATION

The present application relates to audio apparatus, and in particular, but not exclusively to audio apparatus for use in telecommunications applications.

### BACKGROUND OF THE APPLICATION

In conventional situations the environment comprises sound fields with audio sources spread in all three spatial dimensions. The human hearing system controlled by the brain has evolved the innate ability to localize, isolate and comprehend these sources in the three dimensional sound field. For example the brain attempts to localize audio sources by decoding the cues that are embedded in the audio wavefronts from the audio source when the audio wavefront reaches our binaural ears. The two most important cues responsible for spatial perception is the interaural time differences (ITD) and the interaural level differences (ILD). For example an audio source located to the left and front of the listener takes more time to reach the right ear when compared to the left ear. This difference in time is called the ITD. Similarly, because of head shadowing, the wavefront reaching the right ear gets attenuated more than the wavefront reaching the left ear, leading to ILD. In addition, transformation of the wavefront due to pinna structure, shoulder reflections can also play an important role in how we localize the sources in the 3D sound field. These cues therefore are dependent on person/listener, frequency, location of audio source in the 3D sound field and environment he/she is in (for example the whether the listener is located in an anechoic chamber/auditorium/living room).

The perception of the space or the audio environment around the listener is more than only positioning. In comparison to an anechoic chamber (where not much audio energy is reflected from walls, floor and ceilings), a typical room (office, living room, auditorium etc) reflects significant amount of incident acoustic energy. This can be shown for example in FIG. 1 wherein the audio source 1 can be heard by the listener 2 via a direct path 6 and/or any of wall reflection path 4, ceiling reflection path 3, and floor reflection path 5. These reflections allow the listener to get a feel for the size of the room, and the approximate distance between the listener and the audio source. All of these factors can be described under the term externalization.

The 3D positioned and externalized audio sound field has become the de-facto natural way of listening. When presented with a sound field without these spatial cues for long duration, as in a long duration call etc, the listener tends to experience fatigue.

### SUMMARY OF THE APPLICATION

Examples of the present application attempt to address the above issues.

There is provided according to a first aspect a method comprising: receiving at least one audio signal, wherein each audio signal is associated with a source; defining a characteristic associated with each audio signal; and filtering each audio signal dependent on the characteristic associated with the audio signal.

Defining a characteristic may comprise: determining an input; and generating at least one filter parameters dependent on the input.

Determining an input may comprise at least one of: determining a user interface input; and determining an audio signal input.

Determining an input may comprise at least one of: determining an addition of an audio signal; determining a deletion of an audio signal; determining a pausing of an audio signal; determining a stopping of an audio signal; determining an ending of an audio signal; and determining a modification of at least one of the audio signals.

The characteristic may comprise at least one of: a position/location of the audio signal; a distance of the audio signal; an orientation of the audio signal; an activity status of the audio signal; and the volume of the audio signal.

Each audio signal may comprise one from: a multimedia audio signal; a cellular telephony audio signal; a circuit switched audio signal; a packet switched audio signal; a voice of internet protocol audio signal; a broadcast audio signal; and a sidetone audio signal.

Receiving at least one audio signal, wherein each audio signal is associated with a source, may comprise receiving at least two audio signals.

At least two audio signals of the at least two audio signals may comprise a pair of audio channels associated with a single source.

The pair of audio channels associated with a single source may comprise a first audio signal and a reflection audio signal.

At least two audio signals of the at least two audio signals may be associated with different sources.

According to a second aspect there is provided an apparatus comprising at least one processor and at least one memory including computer program code for one or more programs, the at least one memory and the computer program code configured to, with the at least one processor, cause the apparatus at least to perform: receiving at least one audio signal, wherein each audio signal is associated with a source; defining a characteristic associated with each audio signal; and filtering each audio signal dependent on the characteristic associated with the audio signal.

Defining a characteristic may further cause the apparatus to perform: determining an input; and generating at least one filter parameters dependent on the input.

Determining an input may further cause the apparatus to perform at least one of: determining a user interface input; and determining an audio signal input.

Determining an input may further cause the apparatus to perform at least one of: determining an addition of an audio signal; determining a deletion of an audio signal; determining a pausing of an audio signal; determining a stopping of an audio signal; determining an ending of an audio signal; and determining a modification of at least one of the audio signals.

The characteristic may comprise at least one of: a position/location of the audio signal; a distance of the audio signal; an orientation of the audio signal; an activity status of the audio signal; and the volume of the audio signal.

Each audio signal may comprise one from: a multimedia audio signal; a cellular telephony audio signal; a circuit switched audio signal; a packet switched audio signal; a voice of internet protocol audio signal; a broadcast audio signal; and a sidetone audio signal.

Receiving at least one audio signal, wherein each audio signal is associated with a source, may further cause the apparatus to perform receiving at least two audio signals.

At least two audio signals of the at least two audio signals may comprise a pair of audio channels associated with a single source.

The pair of audio channels associated with a single source may comprise a first audio signal and a reflection audio signal.

At least two audio signals of the at least two audio signals may be associated with different sources.

According to a third aspect there is provided an apparatus comprising: means for receiving at least one audio signal, wherein each audio signal is associated with a source; means for defining a characteristic associated with each audio signal; and means for filtering each audio signal dependent on the characteristic associated with the audio signal.

The means for defining a characteristic may further comprise: means for determining an input; and means for generating at least one filter parameters dependent on the input.

The means for determining an input may further comprise at least one of: means for determining a user interface input; and means for determining an audio signal input.

The means for determining an input may further comprise at least one of: means for determining an addition of an audio signal; means for determining a deletion of an audio signal; means for determining a pausing of an audio signal; means for determining a stopping of an audio signal; means for determining an ending of an audio signal; and means for determining a modification of at least one of the audio signals.

The characteristic may comprise at least one of: a position/location of the audio signal; a distance of the audio signal; an orientation of the audio signal; an activity status of the audio signal; and the volume of the audio signal.

Each audio signal may comprises one from: a multimedia audio signal; a cellular telephony audio signal; a circuit switched audio signal; a packet switched audio signal; a voice of internet protocol audio signal; a broadcast audio signal; and a sidetone audio signal.

The means for receiving at least one audio signal may further comprise means for receiving at least two audio signals.

At least two audio signals of the at least two audio signals may comprise a pair of audio channels associated with a single source.

The pair of audio channels associated with a single source may comprise a first audio signal and a reflection audio signal.

At least two audio signals of the at least two audio signals may be associated with different sources.

According to a fourth aspect there is provided an apparatus comprising: an input configured to receive at least one audio signal, wherein each audio signal is associated with a source; a signal definer configured to define a characteristic associated with each audio signal; and a filter configured to filter each audio signal dependent on the characteristic associated with the audio signal.

The signal definer may further comprise: an input determiner configured to determining an input; and a filter parameter determiner configured to generate at least one filter parameters dependent on the input.

The input may further comprise at least one of: a user interface configured to determine a user interface input; and an audio signal determiner configured to determine an audio signal input.

The input determiner may further comprise at least one of: an input adder configured to determine an addition of an audio signal; an input deleter configured to determine a removal of an audio signal; an input pauser configured to determine a pausing of an audio signal; an input stopper configured to determine a stopping of an audio signal; an input terminator configured to determine an ending of an audio signal; and an input changer configured to determine a modification of at least one of the audio signals.

The characteristic may comprise at least one of: a position/location of the audio signal; a distance of the audio signal; an orientation of the audio signal; an activity status of the audio signal; and the volume of the audio signal.

Each audio signal may comprise one from: a multimedia audio signal; a cellular telephony audio signal; a circuit switched audio signal; a packet switched audio signal; a voice of internet protocol audio signal; a broadcast audio signal; and a sidetone audio signal.

The input may be further configured to receive at least two audio signals.

At least two audio signals of the at least two audio signals may comprise a pair of audio channels associated with a single source.

The pair of audio channels associated with a single source may comprise a first audio signal and a reflection audio signal.

At least two audio signals of the at least two audio signals may be associated with different sources.

A computer program product encoded with instructions that, when executed by a computer may perform the method as described herein. An electronic device may comprise apparatus as described above.

A chipset may comprise apparatus as described above.

### BRIEF DESCRIPTION OF DRAWINGS

For better understanding of the present invention, reference will now be made by way of example to the accompanying drawings in which:

FIG. 1 shows an example of room reverberation in audio playback;

FIG. 2 shows schematically an electronic device employing some embodiments of the application;

FIG. 3 shows schematically audio playback apparatus according to some embodiments of the application;

FIG. 4 shows schematically a spatial processor as shown in FIG. 3 according to some embodiments of the application;

FIG. 5 shows schematically a filter as shown in FIG. 4 according to some embodiments of the application;

FIGS. 6 to 9 shows schematically examples of the operation of the audio playback apparatus according to some embodiments of the application;

FIG. 10 shows a flow diagram illustrating the operation of the spatial processor with respect to user interface input; and

FIG. 11 shows a flow diagram illustrating the operation of the spatial processor with respect to signal source input.

### DESCRIPTION OF SOME EMBODIMENTS OF THE APPLICATION

The following describes in more detail possible audio playback mechanisms for the provision of telecommunications purposes. In this regard reference is first made to FIG. 2 which shows a schematic block diagram of an exemplary electronic device or apparatus 10, which may implement embodiments of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media player/recorder (also known as a mp4 recorder/player), or any computer suitable for the processing of audio signals.

The apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The implemented program codes in some embodiments comprise code for performing spatial processing and artificial bandwidth extension as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The spatial processing and artificial bandwidth code in some embodiments can be implemented at least partially in hardware and/or firmware.

The user interface 15 enables a user to input commands to the apparatus 10, for example via a keypad, and/or to obtain information from the apparatus 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, wherein the user interface 15 can be configured to cause the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the ear worn headset 33. Execution of the decoding program code in some embodiments can be triggered as well by an application called by the user via the user interface 15.

The received encoded data in some embodiment can also be stored instead of an immediate presentation via the ear worn headset 33 in the data section 24 of the memory 22, for instance for later decoding and presentation or decoding and forwarding to still another apparatus.

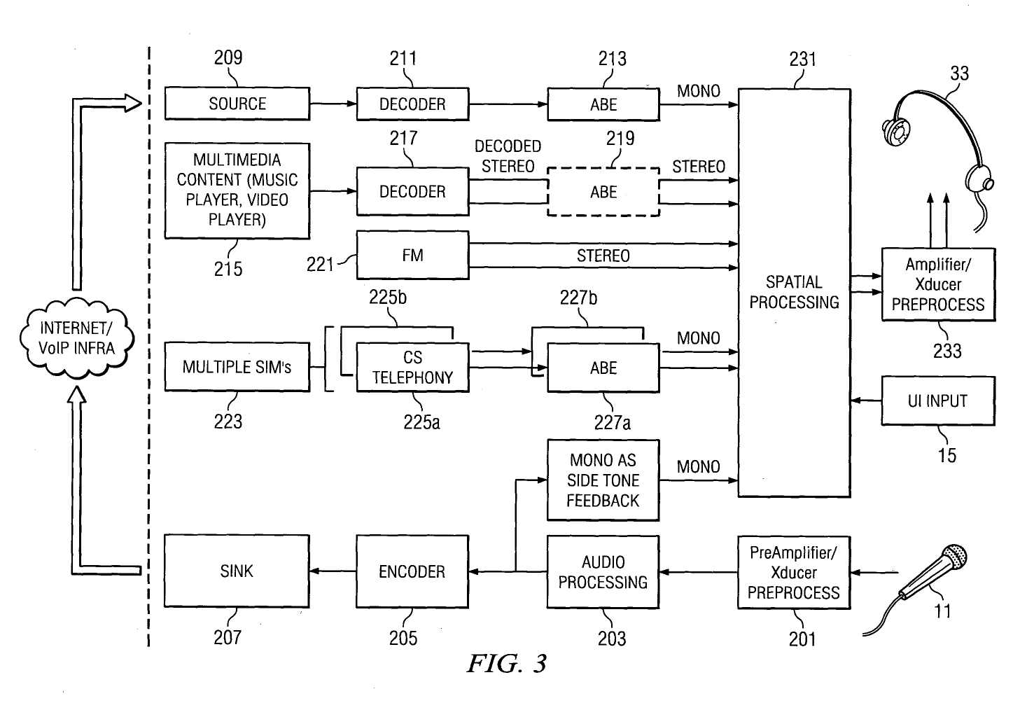

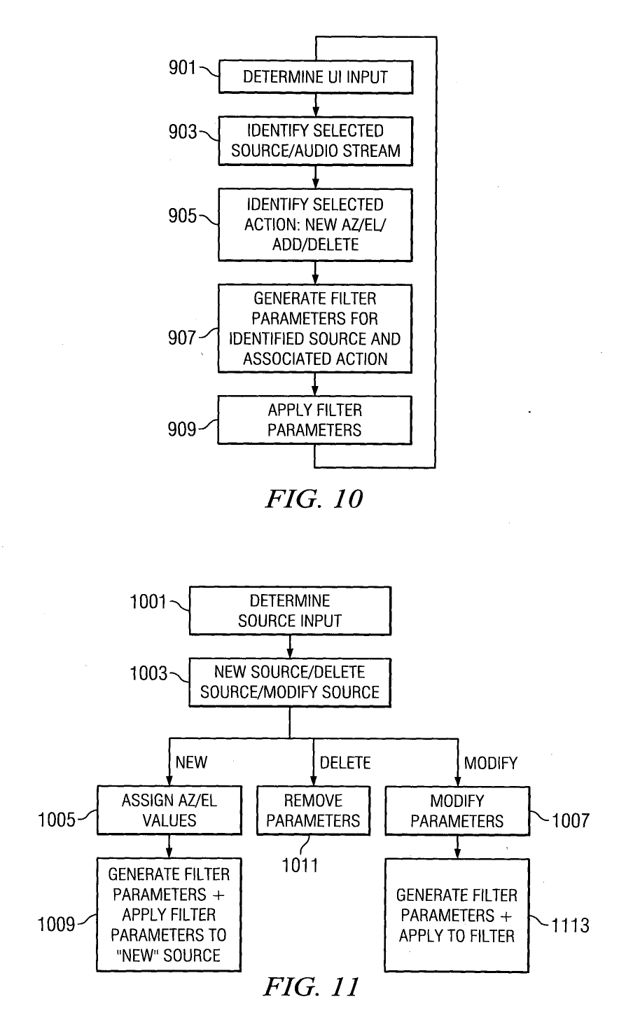

It would be appreciated that the schematic structures described in FIGS. 3 to 5, and the method steps shown in FIGS. 10 to 11 represent only a part of the operation of an apparatus as shown in FIG. 2.

The rendering of mono channels into an earpiece of the handset does not permit the listener to perceive the direction or location of sound source, unlike a stereo rendering (as in stereo headphones or ear worn headsets) where it is possible to impart an impression of space/location to the rendered audio source by applying appropriate processing to the left and right channels. Spatial audio processing spans signal processing techniques adding spatial or 3D cues to the rendered audio signal or which the simplest way to impart directional cues to sound in an azimuth plane is achieved by introducing time and level differences across the left and right channels.

In short 3D audio or spatial audio processing as described herein enables the addition of dimensional or directional components to the sound that has impact on overall listening experience. 3D audio processing can for example be used in gaming, entertainment, training and simulation purposes.

It would be understood that in such embodiments as described herein that no modification to infrastructure side for example by the VoIP service provider or network operator is required. Therefore implementation of such examples as described herein require none of the servers or base stations to be modified nor extra network bandwidth be provided in order to impart the experience. Therefore in such examples and embodiments as described the apparatus is fully backward compatible and suitable in terms of providing this experience to users with older handsets providing the suitable and sufficient requirements of headset processing power can be met.

There is herein described a multitude of use cases involving simultaneous audio sources in mobile devices. For example listening to music (which can also be called audio or multimedia signal or streamed content), FM radio (which can be also known as broadcast audio) or long conference calls (for example from cellular telephony audio or Voice over Internet protocol telephony audio) can long duration listening. Currently mobile devices or user equipment render the audio signals together or are routed on different audio sinks. It is well known that long duration listening to audio over headphones can result in fatigue and can lead to unpleasant experience. In some embodiments of the application as described herein there is a way to handle situations of simultaneous playback in telephony and multimedia playback use case, through spatial audio processing.

In natural situations for example, conversations with individuals or listening to live long music concert or simultaneous conversations, the listener is accustomed to hearing the sounds emanating from outside their head from a particular direction. In other words the listener can often hear a friend or family member from a different direction while watching their favourite music video on TV or music system. In an alternative example, the listener could communicate with another person, the other person's voice being perceived as originating from outside the listener's head. However, this experience (encountered in natural situations) is missing by rendering the telephony channel over a mono audio channel or rendering it as dual mono (same channel being sent to both the speakers). Without explicit additional processing, rendering of the mono audio downlink would sound inside the head and therefore is far from the normal experience of natural conversation.

With respect to FIG. 3 an example implementation of the functional blocks of some embodiments of the application is shown.

The ear worn loudspeaker or headset 33 can comprise any suitable stereo channel audio reproduction device or configuration. For example in following examples the ear worn loudspeakers 33 are conventional headphones however in ear transducers or in ear earpieces could also be used in some embodiments. The ear worn speakers 33 can be configured in such embodiments to receive the audio signals from the amplifier/transducer pre-processor 233.

In some embodiments the apparatus comprises an amplifier/transducer pre-processor 233. The amplifier/transducer pre-processor 233 can be configured to output electrical audio signal in a format suitable for driving the transducers contained within the ear work speakers 33. For example in some embodiments the amplifier/transducer pre-processor can as described herein implement the functionality of the digital-to-analogue converter 32 as shown in FIG. 2. Furthermore in some embodiments the amplifier/transducer pre-processor 233 can output a voltage and current range suitable for driving the transducers of the ear worn speakers at a suitable volume level.

The amplifier/transducer pre-processor 233 can in some embodiments receive as an input, the output of a spatial processor 231.

In some embodiments the apparatus comprises a spatial processor 231. The spatial processor 231 can be configured to receive at least one audio input and generate a suitable stereo (or two-channel) output to position the audio signal relative to the listener. In other words in some embodiments there can be an apparatus comprising: means for receiving at least one audio signal, wherein each audio signal is associated with a source; means for defining a characteristic associated with each audio signal; and means for filtering each audio signal dependent on the characteristic associated with the audio signal.

In some embodiments the spatial processor 231 can further be configured to receive a user interface input signal wherein the generation of the positioning of the audio sources can be dependent on the user interface input.

In some embodiments the spatial processor 231 can be configured to receive at least one of the audio streams or audio sources described herein.

In such embodiments the apparatus comprises a multimedia stream which can be output to the spatial processor as an input. In some embodiments the multimedia stream comprises multimedia content 215. The multimedia content 215 can in some embodiments be stored on or within any suitable memory device configured to store multimedia content such as music, or audio associated with video images. In some embodiments the multimedia content storage 215 can be removable or detachable from the apparatus. For example in some embodiments the multimedia content storage device can be a secure digital (SD) memory card or other suitable removable memory which can be inserted into the apparatus and contain the multimedia content data. In some other embodiments the multimedia content storage device 215 can comprise memory located within the apparatus 10 as described herein with respect to the example shown in FIG. 2.

In some embodiments the multimedia stream can further comprise a decoder 217 configured to receive the multimedia content data and decode the multimedia content data using any suitable decoding method. For example in some embodiments the decoder 217 can be configured to decode MP3 encoded audio streams. In some embodiments the decoder 217 can be configured to output the decoded stereo audio stream to the spatial processor 231 directly. However in some embodiments the decoder 217 can be configured to output the decoded audio stream to an artificial bandwidth extender 219. In some embodiments the decoder 217 can be configured to output any suitable number of audio channel signals. Although as shown in FIG. 3 the decoder 217 is shown outputting a stereo or decoded stereo signal the decoder 217 could also in some embodiments output a mono channel audio stream, or multi-channel audio stream for example a 5.1, 7.1 or 9.1 channel audio stream.

In some embodiments the multimedia stream can comprise an artificial bandwidth extender 219 configured to receive the decoded audio stream from the decoder 217 and output an artificially bandwidth extended decoded audio stream to the spatial processor 231 for further processing. The artificial bandwidth extender can be implemented using any suitable artificial bandwidth extension operation and can be at least one of a higher frequency bandwidth extender and/or a lower frequency bandwidth extender. For example in some embodiments the high frequency content above 4 kHz could be generated from lower frequency content using such a method as described in US patent application US2005/0267741. In such embodiments by using bandwidth extensions, and for example the spectrum above 4 kHz, can contain enough energy to make the binaural cues in the higher frequency range significant enough to make a perceptual difference to the listener. Furthermore in some embodiments the artificial bandwidth extension can be performed to frequencies below 300 Hz.

In the described embodiments herein further streams are described as implementing artificial bandwidth extension. It would be understood that in some embodiments the artificial bandwidth extension methods performed to each audio stream is similar to those described herein with respect to the multimedia stream. In some embodiments the artificial bandwidth extender can be a single device performing artificial bandwidth extensions on each audio stream, or as depicted in FIG. 3 the artificial bandwidth extender can be separately implemented in each media or audio stream input.

In some embodiments the apparatus comprises a broadcast or radio receiver audio stream. The broadcast audio stream in some embodiments can comprise a frequency modulated radio receiver 221 configured to receive frequency modulated radio signals and output a stereo audio signal to the spatial processor 231. It would be appreciated that the frequency modulated receiver 231 could be replaced or added by any suitable radio broadcast receiver such as digital audio broadcast (DAB), or any suitable modulated analogue or digital broadcast audio stream. Furthermore it would be appreciated that in some embodiments the receiver 231 could be configured to output any suitable channel format audio signal to the spatial processor.

In some embodiments the apparatus comprises a cellular input audio stream. In some embodiments the cellular input audio stream can be considered to be the downstream audio stream of a two-way cellular radio communications system. In some embodiments the cellular input audio stream comprises at least one cellular telephony audio stream. As shown in FIG. 3 the at least one cellular telephony audio stream can comprise two circuit switched (CS) telephony streams 225a and 225b, each configured to be controlled (or identified) using a SIM (subscriber identity module) provided by a multiple SIM 223. Each of the cellular telephony audio streams can in some embodiments be passed to an associated artificial bandwidth extender, the artificially bandwidth extended mono-audio stream output from each is passed to the spatial processor 231. In some embodiments the CS telephony streams 225a and 225b can be considered to be audio signals being received over the transceiver 13 as shown in FIG. 2. The cellular telephony audio signal can be any suitable audio format, for example the digital format could be a “baseband” audio signal between 300 Hz to 4 kHz. In such embodiments the artificial bandwidth extender such as shown in FIG. 3 by the first channel artificial bandwidth extender (ABE) 227a and the second channel artificial bandwidth extender (ABE) 227b can be configured to extend spectrum such that audio signal energy above, and/or in some embodiments below, the telephony audio cut-off frequencies can be generated.

In some embodiments the apparatus comprises a voice over internet protocol (VoIP) input audio stream. The VoIP audio stream comprises an audio stream source 209 which can for example be an internet protocol or network input. In some embodiments the VoIP input audio stream source can be considered to be implemented by the transceiver 13 communicating over a wired or wireless network to the internet protocol network. For example, in some embodiments the VoIP source 209 signal comprises a VoIP data stream encapsulated and transmitted over a cellular telephony wireless network. The VoIP audio stream source 209 can be configured to output the VoIP audio signal to the decoder 211.

The VoIP input audio stream can in some embodiments comprise a VoIP decoder 211 configured to receive the VoIP audio input data stream and produce a decoded input audio data stream. The decoder 211 can be any suitable VoIP decoder.

Furthermore in some embodiments the VoIP audio input stream comprises an artificial bandwidth extender 213 configured to receive the decoded VoIP data stream and output an artificially bandwidth extended audio stream to the spatial processor 231. In some embodiments the output of the VoIP audio input stream is a mono or single channel audio signal however it would be understood that any suitable number or format of audio channels could be used.

Furthermore in some embodiments the apparatus comprises a uplink audio stream. In the example shown in FIG. 3 the uplink audio stream is a voice over internet (VoIP) uplink audio stream. The uplink audio stream can comprise in some embodiments the microphone 11 which is configured to receive the acoustic signals from the listener/user and output an electrical signal using a suitable transducer within the microphone 11.

Furthermore the uplink stream can comprise a preamplifier/transducer pre-processor 201 configured to receive the output of the microphone 11 and generate a suitable audio signal for further processing. In some embodiments the preamplifier/transducer pre-processor 201 can comprise a suitable analogue-to-digital converter (such as shown in FIG. 2) configured to output a suitable digital format signal from the analogue input signal from the microphone 11.

In some embodiments the uplink audio stream comprises an audio processor 203 configured to receive the output of the preamplifier/transducer pre-processor 201 (or microphone 11 in such embodiments that the microphone is an integrated microphone outputting suitable digital format signals) and process the audio stream to be suitable for further processing. For example in some embodiments the audio processor 203 is configured to band limit the audio signal received from the microphone such that it can be encoded using a suitable audio coder. In some embodiments the audio processor 201 can be configured to output the audio processed signal to the spatial processor 231 to be used as a side tone feedback audio mono-channel signal. In other embodiments the audio processor default uplink can output the audio processed signal from the microphone to the encoder 205.

In some embodiments the uplink audio stream can comprise an encoder 205. The encoder can be any suitable encoder, such as in the example shown in FIG. 3 a VoIP encoder. The encoder 205 can output the encoded audio stream to a data sink 207.

In some embodiments the uplink audio stream comprises a sink 207. The sink 207 is configured in some embodiments to receive the encoded audio stream and output the encoded signal via a suitable conduit. For example in some embodiments the sink can be a suitable interface to the internet or voice over internet protocol network used. For example in some embodiments the sink 207 can be configured to encapsulate the VoIP data using a suitable cellular telephony protocol for transmission over a local wireless link to a base station wherein the base station then can pass the VoIP signal to the network of computers known as the internet.

It would be understood that in some embodiments the apparatus can comprise further uplink audio streams. For example there can in some embodiments be a cellular telephony or circuit switched uplink audio stream. In some embodiments the further uplink audio streams can re-use or share usage of components with the uplink audio stream. For example in some embodiments the cellular telephony uplink audio stream can be configured to use the microphone/preamplifier and audio processor components of the uplink audio stream and further comprise a cellular coder configured to apply any suitable cellular protocol coding on the audio signal. In some embodiments any of the further uplink audio streams can further comprise an output to the spatial processor 231. The further uplink audio streams can in some embodiments output to the spatial processor 231 an audio signal for side tone purposes.

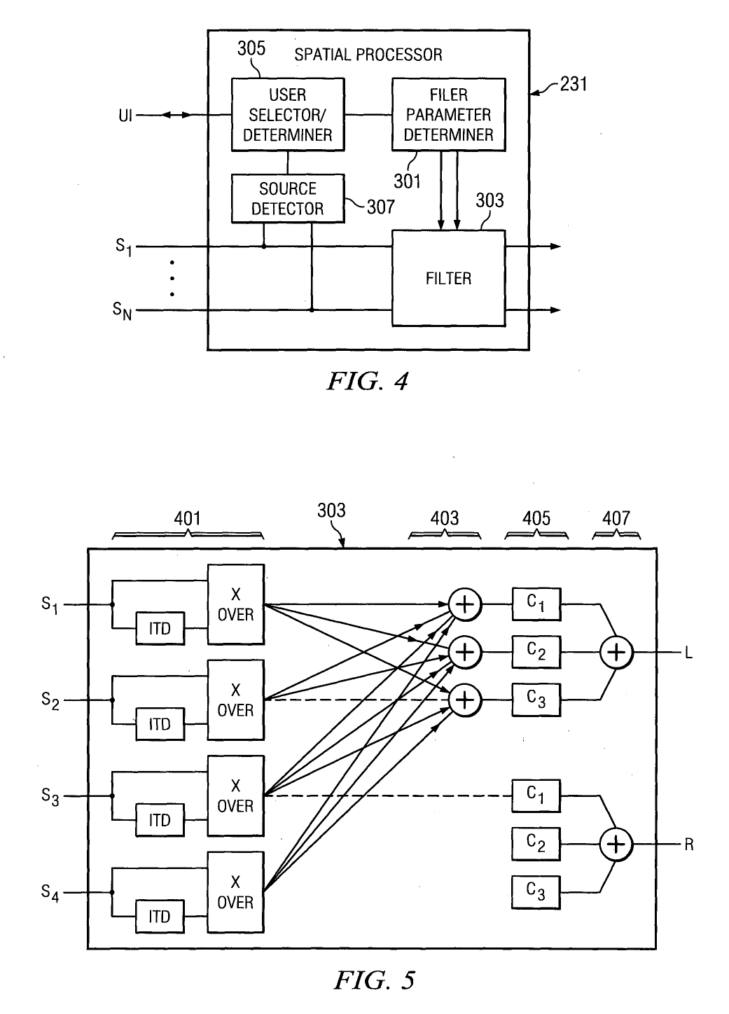

With respect to FIG. 4 the spatial processor 231 is shown in further detail.

The spatial processor 231 can in some embodiments comprise a user selector/determiner 305. The user selector/determiner 305 can in some embodiments be configured to receive inputs from the user interface and be configured to control the filter parameter determiner 301 dependent on the user input. The user selector/determiner 305 can furthermore in some embodiments be configured to output to the user interface information for displaying to the user the current configuration of input audio streams. For example in some embodiments the user interface can comprise a touch screen display configured to display an approximation to the spatial arrangement output by the spatial processor, which can also be used to control the spatial arrangement by determining on the touch screen input instructions.

In some embodiments the user selector/determiner can be configured to associate identifiers or other information data with each input audio stream. The information can for example indicate whether the audio source is active, inactive, muted, amplified, the relative ‘location’ of the stream to the listener, the desired ‘location’ of the audio stream, or any suitable information for enabling the control of the filter parameter generator 301. The information data in some embodiments can be used to generate the user interface displayed information.

In some embodiments the user selector/determiner 305 can further be configured to receive inputs from a source determiner 307.

In some embodiments the spatial processor 231 can comprise a source determiner 307. The source determiner 307 can in such embodiments be configured to receive inputs from each of the input audio streams and/or output audio streams input to the spatial processor 231. In some embodiments the source determiner 307 is configured to assign a label or identifier with the input audio stream. For example in some embodiments the identifier can comprise information on at least one of the following, the activity of the audio stream (whether the audio stream is active, paused, muted, inactive, disconnected etc), the format of the audio stream (whether the audio stream is mono, stereo or other multichannel), the audio signal origin (whether the audio stream is multimedia, circuit switched or packet switched communication, input or output stream). This indicator information can in some embodiments be passed to the user selector/determiner 305 to assist in controlling the spatial processor outputs. Furthermore in some embodiments the indicator information can in some embodiments be passed to the user to assist the user in configuring the spatial processor to produce the desired audio output.

The spatial processor 231 can in some embodiments comprise a filter parameter determiner 301 configured to receive inputs from the user selector/determiner 305 based on for example a user interface input 15, or information associated with the audio stream describing the default positions or locations, or desired or requested positions or locations of the audio streams to be expressed. The filter parameter determiner 301 is configured to output suitable parameters to be applied to the filter 303.

The spatial processor 231 can further be configured to comprise a filter 303 or series of filters configured to receive each of the input audio streams, such as for example from the VoIP input audio stream, the multimedia content audio stream, the broadcast receiver audio stream, the cellular telephony audio stream or streams, and the side tone audio stream and process these to produce a suitable left and right channel audio stream to be presented to the amplifier/transducer pre-processor 233. In some embodiments the filter can be configured such that at least one of the sources, for example a sidetone audio signal, can be processed and output as a dual mono audio signal. In other words the sidetone signal from microphone is output unprocessed to both of the headphone speakers. In such embodiments the ‘unprocessed’ or ‘direct’ audio signal is used because the listener/user would feel comfortable listening to their own voice from inside the head without any spatial processing as compared to all the other sources input to the apparatus such as music, a remote caller's voice, which can be processed and be positioned and externalized. In some embodiments the spatial processor can in some embodiments comprise a stereo mixer block to add some of the signals without positioning processing to the audio signals that have been position processed.

In some embodiments the filter parameter determiner 301 is configured to generate basis functions and weighting factors to produce directional components and weighting factors for each basis function to be applied by the filter 303. In such embodiments each of the basis functions are associated with an audio transfer characteristic. This basis function determination and application is shown for example in Nokia published patent application WO2011/045751.

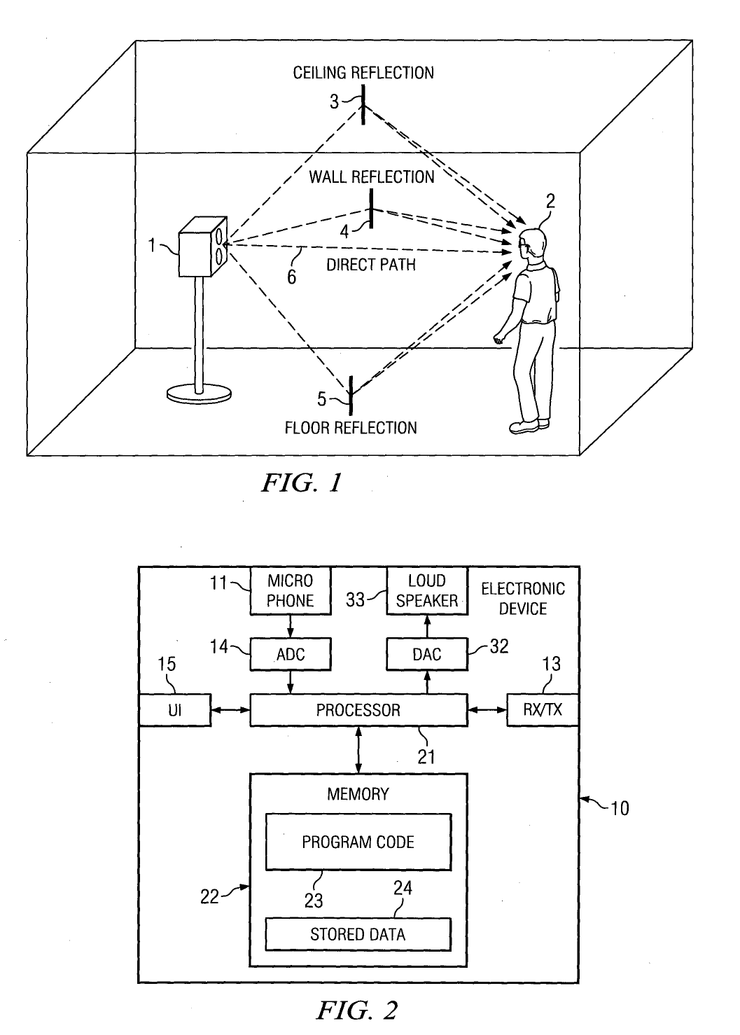

An example of a basis function/weighting factor filter configuration is shown in FIG. 5. The filter 303 can in some embodiments be a multi-input filter wherein the audio stream inputs S₁ to S₄ are mapped to the two channel outputs L and R by splitting each input signal and applying an inter time difference to one of the pairs in a stream splitter section 401, summing associated sources pairs in a source combiner section 403 and then applying basis functions and weighting factors to the combinations in a function application section 405 before further combining the resultant processed audio signals in a channel combiner section 407 to generate the left and right channel audio values simulating the positional information. In some embodiments the input such as S2 can be a delayed, scaled or filtered version of S1. This delayed signal can in some embodiments be used to synthesize a room reflection, such as a floor or ceiling reflection such as shown in FIG. 1.

In such embodiments the basis functions and weighting factor parameters generated within the filter parameter determiner 301 can be passed to the filter 303 to be applied to the various audio input streams.

In some other embodiments each audio stream for example the mono audio source (raw audio samples) can be passed through a pair of position specific digital filters called head related impulse response (HRIR) filters. For example to position each of the audio streams audio sources S₁, S₂, . . . , Sₙ, the audio streams can be passed through a pair of position (azimuth and elevation) specific HRIR filters (one HRIR for right ear and one HRIR for left ear for the intended elevation and azimuth). These filtered stereo signals are then mixed and the resultant stereo signal, if needed, is passed through a reverberation algorithm. In such embodiments the reverberation algorithm can be configured to synthesize early and late reflections due to wall, floor, ceiling reflections that are happening in a typical listening environment.

Furthermore it would be understood that the spatial processor 231 and filter 303 can be implemented using any suitable digital signal processor to generate the left and right channel audio signals from the input audio streams based on the ‘desired’ audio stream properties such as direction and power and/or volume levels.

In other words the means for defining a characteristic as described herein can further comprise: means for determining an input; and means for generating at least one filter parameters dependent on the input. Furthermore the means for determining an input can in some embodiments further comprise at least one of: means for determining a user interface input; and means for determining an audio signal input.

As described herein in some embodiments the means for determining an input further comprise at least one of: means for determining an addition of an audio signal; means for determining a deletion of an audio signal; means for determining a pausing of an audio signal; means for determining a stopping of an audio signal; means for determining an ending of an audio signal; and means for determining a modification of at least one of the audio signals.

Furthermore in some embodiments the characteristic comprises at least one of: a position/location of the audio signal; a distance of the audio signal; an orientation of the audio signal; an activity status of the audio signal; and the volume of the audio signal.

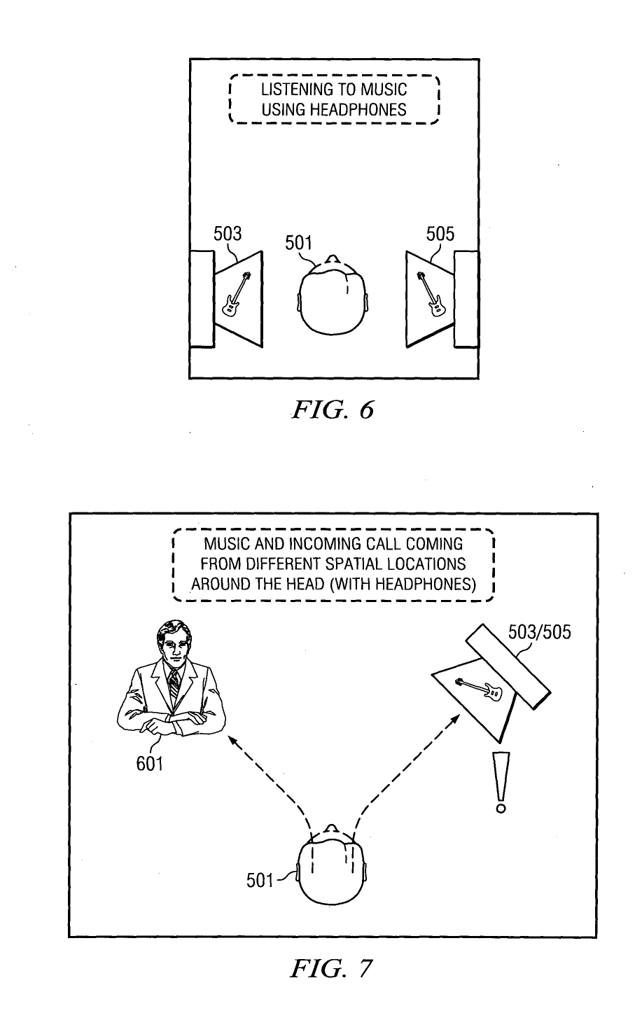

With respect to FIGS. 6 to 9 and FIGS. 10 to 11, a series of examples of the application of some embodiments as shown functionally in FIGS. 3, 4 and 5 are shown.

For example in FIG. 6 the listener 501 is shown listening to a source for example a source of music such as, for example, produced via the multimedia content stream or broadcast audio stream whereby the stereo content of the audio is presented with a directionality on either side of the listener such that the listener perceives to their left a first audio channel 503 and to their right a second audio channel 505. In other words the source detector 307 is configured to determine that there is at least one audio stream active, in this example the multimedia content or broadcast audio stream. The source detector 307 can be configured to pass this information onto the user selector/determiner 305. The user selector/determiner 305 can then ‘position’ the audio stream. In some embodiments the user selector/determiner 305 can, without any user input influence, control the filter parameter determiner 301 to generate filter parameters which enable the audio stream to pass the filter 303 without modifying the left and/or right channel relative ‘experienced’ position or orientation.

With respect to FIGS. 7 and 11 an example of the operation of the spatial processor 231 introducing a new (or further) audio stream is shown. For example as shown in FIG. 7 the apparatus can be configured to enhance or supplement the currently presented (as shown with respect to FIG. 6) multimedia content stream channels shown in FIG. 6 as the left channel 503 and right channel 505 by any further suitable audio stream. For example the spatial processor 231 and in some embodiments the source detector 307 can be configured to determine a source input, which in this scenario is a new cellular input audio stream. However it would be understood that the first and second or further audio streams or audio signals can be any suitable audio stream or signal.

The determination of a source input has been received can be seen in FIG. 11 by step 1001.

The spatial processor 231 can furthermore in some embodiments determine whether a stream input is a new stream or source. The source detector 307 in some embodiments can determine the source input as being a new or activated stream either by monitoring the source or stream input against a determined threshold or by receiving information or indicators about the source or stream either sent with the audio stream or separate from the audio stream.

The determination of whether the input is a new source or stream can be seen in FIG. 11 by step 1003.

In some embodiments the spatial processor 231, and in some embodiments the user selector/determiner 305, having determined the input (or an activated input) is a ‘new’ stream or source, can be configured to assign some default parameters associated with the ‘new’ stream or source input. For example the default parameters can comprise defining an azimuth or elevation value associated with the new source which positions the source or stream audio signal relative to the listener or user of the apparatus. In some embodiments these default parameters associated with the source can be position/location of the source relative to the ‘listener’ and/or orientation of the source. Orientation in 3D audio can determine in some embodiments whether the source is directed or facing the listener or facing away from the listener.

The determination or generation of default azimuth or elevation values associated with an audio stream or signal source is shown in FIG. 11 by step 1005.

The spatial processor 231, and in some embodiments the user selector/determiner 305 can control the filter parameter determiner to generate a set of filter parameters which can be applied to the spatial filter to cause the spatial processor to produce an audio signal where the audio stream has the default position or other default characteristics. For example in some embodiments the filter parameter determiner 201 can be configured to dependent on the default parameters or characteristics generate the weighting parameters and basis functions such that the audio stream is processed to produce the desired spatial effect.

The generation of the filter parameters and the application of the filter parameters for the initial or default position of the ‘new’ audio stream or source can be seen in FIG. 11 by step 1009.

For example as shown in FIG. 7 the incoming call audio stream can be presented at a different spatial location or direction to the multimedia audio stream such as shown in FIG. 7 by the VoIP icon 601 which is located away from the spatial location of the multimedia content audio stream icon 503/505.

In some embodiments the initial or default position of the ‘new’ audio stream of source is output by the user selector/determiner 305 and displayed or shown by the user interface to the listener or user of the apparatus. Thus in some embodiments the user of the apparatus is shown a representation of the ‘location’ of the first and second or further audio streams relative to the listener.

In some embodiments the input can be that the signal stream or source has gone inactive or been disconnected, muted, paused, stopped or deleted. For example in some embodiments the source detector 307 can determine the ending of the source or stream such as be detecting an input volume or power below a determined threshold value for a determined period and pass this information in the form of a source or stream associated message or indicator to the spatial processor user selector/determiner. Furthermore in some embodiments the user interface can further provide a stop, and/or pause, and/or mute message to the user selector/determiner 305.

For example in some embodiments when a call ends and the input audio stream ends the user selector/determiner 305 can be configured to remove the source associated parameters, such as the azimuth and elevation values from the spatial processor and control the filter parameter determiner to reset or remove the filter parameter values.

The operation of checking the input is a source ‘deletion’ event operation is shown in FIG. 11 as step 1003.

Furthermore the operation of removing the source associated azimuth and elevation values from the spatial processor is shown in FIG. 11 by step 1011.

In some embodiments the user selector/determiner 305 can be configured to determine where there is a ‘modification’ input, in other words the source input is not a new source or a source deletion. In such embodiments the user selector/determiner 305 can be configured to perform a source amendment or change operation. In some embodiments this can for example be implemented by determining a user interface input and as such cause the spatial processor to check or perform a user interface check.

Thus in some embodiments the user selector/determiner 305 on determining a modification or amendment input can be configured to modify the parameters, such as azimuth and elevation (or position/location/orientation) associated with the source and/or audio stream and further inform the filter parameter determiner (and/or inform the user interface) of this modification.

The operation of modifying the source or signal stream parameters and/or characteristics is shown in FIG. 11 by step 1007.

Furthermore the filter parameter determiner 301 on receiving the modification information can in some embodiments be configured to generate filter parameters which reflect these characteristic or parameter modifications.

These generated filter parameters can then be applied to the filter to generate the requested modifications to the output audio signals.

The operation of generating and applying the filter parameters for the modification input is shown in FIG. 11 by step 1113.

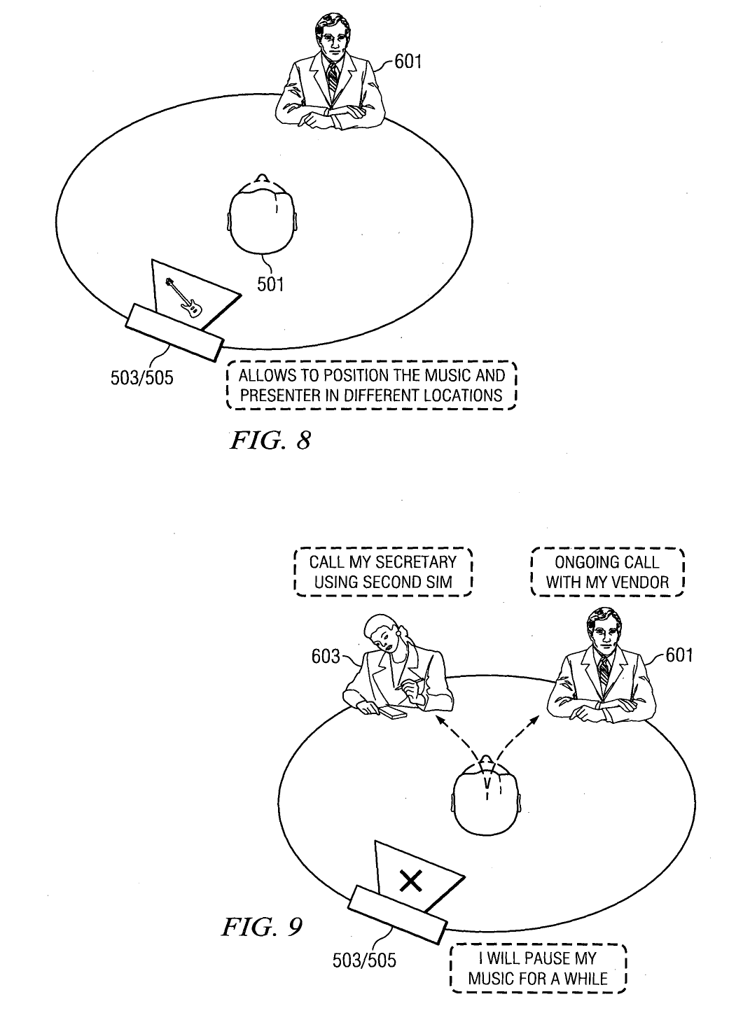

For example FIG. 8 shows a source input in the form of a positioning movement of the audio streams wherein the position of the multimedia content and VoIP audio streams are changed. In some embodiments this can be performed by the listener using the user interface to send information or messages to the user selector/determiner 305 to cause a change in position of the music and call directions. In some embodiments the addition or removal of other streams or sourced can have an associated modification operation. For example in some embodiments the addition of a further source to the positional configuration of audio streams causes the previously output streams to move to ‘create room’ for the new streams. Similarly in some embodiments the deletion or removal of a source or stream can be configured to allow the remaining sources or streams to ‘fill the positional gap’ created by the deletion or removal. Thus in some embodiments an addition or deletion input can generate a further modification operation cycle.

In some further embodiments the characteristics of the audio stream can be modified based on information associated with the audio stream or source. For example in some embodiments the other party or other parties who are communicating with the user or listener can be configured to “move their position” by communicating a desired location or position to assist in distinguishing between other parties.

Thus for example as shown in FIG. 8, the VoIP input audio stream represented by the VoIP icon 601 is shown as having been moved from the initial position relative to the user in a clockwise direction, and at the same time the multimedia content audio stream represented by the multimedia content audio stream icon 503/505 is similarly moved about the listeners head.

As shown in FIG. 10, a user interface check operation according to some embodiments is shown. The user interface check can be performed in some embodiments to monitor ‘inputs’ received from the user interface. The spatial processor and in some embodiments the user selector/determiner 305 can for example determine whether or not a user interface input has been detected.

The determination of user interface input is shown in FIG. 10 by step 901.

Furthermore having determined that there is a user interface input, the user selector/determiner 305 in some embodiments can determine or identify the selected source or audio stream that has been selected by the user interface.

The identification of the selected source is shown in FIG. 10 by step 903.

In some embodiments the user selector/determiner 305 can then identify the selected action or input associated with the source. For example in some embodiments the action is an addition of an audio stream—such as the side tone input generated when the user initiates a call. For example as shown in FIG. 9 a second call is opened at the request of the user operating the user interface and the user selector/determiner can be configured to control the filter parameter determiner 301 to generate filter parameters such that the second call input audio stream has a directional component different from the first (current) call and the music also currently being output.

In some embodiments the input can be identified as a deletion action (which could in some embodiments include muting, pausing or stopping) the audio stream or source. For example as shown in FIG. 9 the music is paused or muted temporarily whilst there are calls being performed between the listener and a vendor or first source 601 and also with a second source 603.

Furthermore in some embodiments the user interface input can be identified as being a modification or amendment action such as previously discussed in relation to FIG. 8, where the action is one of a rotation or new azimuth or elevation for the sources or audio streams.

The identification of the action associated with the source or audio stream is shown in FIG. 10 by step 905.

In such embodiments the selected action is identified and a suitable response can then be generated by the filter parameter determiner 301.

The generation of filter parameters for the identified source and action is shown in FIG. 10 by step 907.

For example in some embodiments the filter parameter determiner 301 can perform a basis function determination or weighting factor determination or ITD determination or the delay determination between S1 and S2 (for synthesizing room reflections appropriately) such that the output produced by the audio spatial processor filter 303 follows the required operation.

These generated function and weighting factor values can then be passed to the filter to then be applied. The operation of application of these parameters to the filter is shown in FIG. 10 by step 909.

Thus user equipment may comprise a spatial processor such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus at least some embodiments there may be apparatus comprising at least one processor and at least one memory including computer program code the at least one memory and the computer program code configured to, with the at least one processor, cause the apparatus at least to perform: receiving at least one audio signal, wherein each audio signal is associated with a source; defining a characteristic associated with each audio signal; and filtering each audio signal dependent on the characteristic associated with the audio signal.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

Thus at least some embodiments there may be a computer-readable medium encoded with instructions that, when executed by a computer perform: receiving at least one audio signal, wherein each audio signal is associated with a source; defining a characteristic associated with each audio signal; and filtering each audio signal dependent on the characteristic associated with the audio signal.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-23. (canceled)

24. An apparatus comprising at least one processor and at least one memory including computer program code for one or more programs, the at least one memory and the computer program code configured to, with the at least one processor, cause the apparatus at least to:
output at least one audio signal;
receive at least one further audio signal;
define at least one characteristic associated with the at least one further audio signal;
filter the at least one further audio signal dependent on the at least one characteristic; and
simultaneously output the at least one audio signal and the at least one further audio signal.

25. The apparatus as claimed in claim 24, wherein causing the apparatus to define the at least one characteristic further causes the apparatus to:
determine at least one input audio stream; and
generate at least one filter parameter dependent on the at least one input audio stream.

26. The apparatus as claimed in claim 25, wherein causing the apparatus to generate the least one filter parameter is associated with at least one of:
a spatial location of the at least one further audio signal;
a spatial distance of the at least one further audio signal;
an activity of the at least one further audio signal; and
a volume of the at least one further audio signal.

27. The apparatus as claimed in claim 24, wherein the at least one audio signal and the at least one further audio signal comprises one of:
a multimedia audio signal;
a cellular telephony audio signal;
a circuit switched audio signal;
a packet switched audio signal;
a voice of internet protocol audio signal;
a broadcast audio signal; and
a sidetone audio signal.

28. The apparatus as claimed in claim 24, wherein causing the apparatus to filter produces a spatial effect for at least one of the at least one audio signal and the at least one further audio signal.

29. The apparatus as claimed in claim 24, wherein causing the apparatus to simultaneously output positions the at least one further audio signal away from the at least one audio signal.

30. The apparatus as claimed in claim 24, wherein causing the apparatus to receive at least one further audio signal generates a stereo output to position the at least one further audio signal.

31. The apparatus as claimed in claim 24, wherein the at least one audio signal and the at least one further audio signal are associated with different sources.

32. The apparatus as claimed in claim 24, wherein the at least one audio signal and the at least one further audio signal are associated with the same source.

33. The apparatus as claimed in claim 24, wherein causing the apparatus to filter further causes the apparatus to position the at least one audio signal and the at least one further audio signal relative to each other.

34. The apparatus as claimed in claim 24, wherein the apparatus is configured to receive a user interface input.

35. The apparatus according to claim 34, wherein the simultaneous output is dependent on the user interface input.

36. The apparatus as claimed in claim 24, wherein the at least one characteristic is associated with the at least audio signal.

37. The apparatus according to claim 36, wherein the at least one characteristic is associated with different sources based on the at least one audio signal and the at least one further audio signal.

38. A method comprising:
outputting at least one audio signal;
receiving at least one further audio signal;
defining at least one characteristic associated with the at least one further audio signal; and
filtering the at least one further audio signal dependent on the at least one characteristic; and
simultaneously outputting the at least one audio signal and the at least one further audio signal.

39. The method as claimed in claim 38, wherein defining the at least one characteristic further comprises at least one of:
determining at least one input audio stream; and
generating at least one filter parameter dependent on the at least one input audio stream.

40. The method as claimed in claim 39, wherein generating the least one filter parameter comprises at least one of:
determining a spatial location of the at least one further audio signal;
determining a spatial distance of the at least one further audio signal;
determining an activity of the at least one further audio signal; and
determining a volume of the at least one further audio signal.

41. The method as claimed in claim 38, wherein filtering the at least one further audio signal comprises producing a spatial effect for at least one of the at least one audio signal and the at least one further audio signal.

42. The method as claimed in claim 38, wherein simultaneously outputting comprises positioning the at least one further audio signal away from the at least one audio signal.

43. The method as claimed in claim 38, wherein the method further comprises at least one of:
receiving a user interface input.
simultaneously outputting based on the user interface input.
